(19) United States
(12) Patent Application Publication
(10) Pub. No.: US 2013/0309961 A1
(43) Pub. Date: Nov. 21, 2013

(54) Method and system for maintaining communication with inclined orbit geostationary satellites

(71) Applicants: Wah Lim, Newport Beach, CA (US); Jeremiah Salvatore, Redondo Beach, CA (US)

(72) Inventors: Wah Lim, Newport Beach, CA (US); Jeremiah Salvatore, Redondo Beach, CA (US)

(21) Appl. No.: 12/657,188

(22) Filed: Jan. 14, 2010

Related U.S. Application Data
(60) Provisional application No. 61/205,994, filed on Jan. 27, 2009.
(60) Provisional application No. 61/209,994, filed on Mar. 13, 2009.

(51) Int. Cl. H04B 7/185

(52) U.S. Cl. CPC H04B 7/1851
USPC 455/13.3

(57) ABSTRACT

An inexpensive method and system for maintaining communication between fixed receivers on the earth surface having fixed antennas and inclined orbit geostationary satellites. In preferred embodiments the fixed antennas of each receiver are provided with more than one feed horn (such as three or more feed horns) each positioned to form a beam with its antenna in a slightly different direction from beams of the other feed horns in the north-south direction. An algorithm is developed based on the known daily swings of the inclined orbit geostationary satellite which determines which of the feed horns provides a beam providing the maximum signal from the satellite.

The present invention relates to communication systems utilizing geostationary communication satellites and in particular to those systems when the satellite is in an inclined orbit. This application claims the benefit of Provisional Patent Applications No. 61/205,994, filed Jan. 16, 2009 and No. 61/209,994 filed Mar. 13, 2009.

### FIELD OF INVENTION

### Background of the Invention

Typically geostationary satellites are maintained in an orbit position that is synchronized with the rotation of the earth so that the satellite appears to be in a stationary position above the surface of the earth. Transmit and received antennas on earth communicating with the satellite can therefore be maintained in a fixed position. To maintain the satellite in this geostationary position relative to the surface of the earth booster rockets must be fired periodically to correct the satellites position both east-west and north-south, each correction requiring booster rocket fuel. Much more fuel is required for the north-south correction than the east-west correction. At some point the satellite runs out of fuel which means the end of life for the satellite. A common practice toward the end of life, when fuel is low, is to correct for only ease-west deviations and allow the satellite to swing back and forth in its apparent north-south positions. The satellite will thus appear from fixed positions on earth to move back and forth in the north-south direction across the equator plane each day. The swing increases about 0.87 degrees per year. Various techniques have been proposed to permit earth bound antennas to track the satellites so as to extend the life of the communication system using the satellite. These prior art tracking systems are typically complicated and expensive.

Current state of the art ground antenna designed to receive signals from an inclined orbit geostationary satellite uses a tracking antenna that continuously track the movement of the satellite in inclined orbit that traces a FIG. 8 track in the sky. Because tracking antennas are expensive and complex, they prevent inclined orbit geostationary orbit satellite from being use for very small aperture satellite data services (VSAT) application and for direct to home satellite television (DTH) services.

Prior art patents relating to the subject matter of the present invention include U.S. Pat. No. 6,504,504 for fixed, multi-feed tracking antenna and U.S. Pat. Nos. 5,905,471 and 7,391,384 for active elements antenna. Other related patents include U.S. Pat. Nos. 4,538,175, 5,905,471, 6,952,188, 7,119,754, 5,859,620, 3,999,184, 4,739,337, 5,764,185, 4,035,805, 5,900,836, 7,119,754, 6,952,188, 5,077,561 and 5,075,682 relating to miscellaneous satellite receive antenna and tracking antenna. All of the above patents are incorporated herein by reference.

### Geostationary Satellite Operations

Most modern commercial communications satellites, broadcast satellites operate in geostationary orbits. (Russian television satellites have used elliptical Molniya and Tundra orbits due to the high latitudes of the receiving audience.) A geostationary orbit for a satellite is a geosynchronous orbit directly above the Earth's equator (0° latitude), with a period equal to the Earth's rotational period and a zero orbital eccentricity. Geostationary orbits can be achieved only very close to a ring 35,786 km (22,236 ml) directly above the equator. This requires an orbital velocity of 3.07 km/s (1.91 ml/s) for a period of 1436 minutes, which equates to almost exactly one earth day or ˜23.93 hours known as the sidereal day. Due to the constant 0° latitude and circularity of geostationary orbits, satellites in geostationary orbit differ in location by longitude only. This means that all geostationary satellites have to exist on this ring. Once the satellite is put into its orbital arc around the equator, the ground operators have to adjust the orbit location periodically in order to keep the satellite in its exact assigned position by a series of maneuvers call station-keeping. The reasons a geostationary satellite will not remain in place if no “station keeping” maneuvers are being performed periodically are because of forces acting on the satellite.

Geosynchronous/geostationary spacecraft motion, orbit perturbations and station-keeping maneuvers can be best understood by defining the orbit in terms of longitude, eccentricity and inclination vectors. The longitude vector has two components, longitude, L, and drift rate, d. The eccentricity vector has two components: magnitude of the eccentricity, e (a measure of the difference between apogee and perigee altitudes) and a direction pointing to perigee in inertial space (defined by the angle between perigee and the direction of Aries in the equatorial plane relative to the earth). FIG. 1 illustrates the e vector in the equator where the reference axis Aries represents the point where the sun rises above the equator on March 21. The inclination vector has two components: magnitude of the inclination, i (tilt of the orbit plane relative to the equator), and a direction pointing to the ascending in inertial space (defined by the angle between the point that a spacecraft rises above the equator and the direction of Aries in the equatorial plane as shown in FIG. 1. This angle is called the right ascension of the ascending node, RAi). The direction of the e vector (location of perigee) can then be defined by the sum angle RAi+w, where w is the classical element, the argument of perigee. The location of the spacecraft in the equatorial plane can then be defined by the sum angle RAi+w+M, where M is the classical element, mean anomaly.

FIG. 2 illustrates an edge view of the spacecraft orbit plane relative to the equatorial plane from the point of view of an inertial observer. These six components (L, d, e, RAi+w, i, RAi) are substitutes for the classical six elements (a, e, i, M, w, RAi) where a is the classical element, the semimajor axis. They permit a lucid discussion of (i) spacecraft motion at a mean station longitude, (ii) perturbations to the geosynchronous/geostationary orbit, and (iii) what standard station-keeping maneuvers are designed to accomplish.

The relationship between longitude and both the e and i vectors can be established by first noting that the sunline in the equatorial plane rotates counterclockwise from Aries (after March 21) in FIG. 1 at ˜0.986 deg/day. On any day after March 21, the sun is at the Greenwich Meridian or zero longitude at 12 noon GMT. The right ascension of the sunline (RAs) on a typical day at this time (12 GMT) is shown in FIG. 1. If a spacecraft is “stationary” at L deg east longitude, it must be L deg ahead of the sunline at this time (12 GMT). The position of a spacecraft in FIG. 1 at any time of interest is:

SC position=RAi+w+M

The requirement for a spacecraft to be stationary at L deg east longitude requires:

RAi+w+M−RAs=L at 12 GMT on any day of the year or

w+M=L+RAs−RAi at 12 GMT on any day of the year

The time that the spacecraft arrives at the ascending node (w+M=0 deg) on any specific day is essential to defining the latitude timeline on that day since from FIG. 2, the latitude is approximately

Lat=i sin(w+M)

The angle (w+M) increases at a nearly constant rate of 360 deg/23.93 hr. The time of day that the spacecraft arrives at the ascending node is then defined as

TIME(i=0)=12 GMT−(L+RAs−RAi)(23.93 hr/360 deg)

Note that the advance of the right ascension of the sun every day makes the arrival of the spacecraft at the ascending node occur ˜4 minutes earlier each day. The right ascension of the ascending node of the spacecraft can vary due to orbital perturbations that will now be discussed.

### Satellite Station Keeping

To keep a geostationary satellite fixed in its intended orbit, a series of periodic manuevers must be performed using small on board thrusters rockets. Two primary sets of manuevers are: East-West control to keep the satellite near the longitude it is assigned and from drifting in the east-west direction, and North-South control to keep the satellite near zero latitude and not drifting in the north-south direction.

### East-West Motion, Perturbations, Station Keeping

The average diurnal spacecraft longitude is the center of an ellipse at synchronous radius; the semi major and semi minor axes are proportional to eccentricity. The spacecraft instantaneous position moves clockwise along the ellipse and is defined by the mean anomaly, M, the angle of the spacecraft relative to perigee. The average longitude L of a geosynchronous/geostationary spacecraft is disturbed by “triaxiality” or the three dimensional ellipsoidal shape of the earth. There are only two stable longitudes (75 deg E, 254 deg E). Any spacecraft stationed at a longitude within +/−90 deg of either of these nodes will drift towards toward the nearest stable longitude. The longitude of a spacecraft at any specific time can be defined as

L=Lo+dt+2e(sin M)

where Lo is the east longitude at t=0, d is the instanteous drift rate, e is the current eccentricity, and M is the mean anomaly. The spacecraft is typically contained in an east/west longitude “box” of 0.1 deg. Therefore, when any spacecraft exceeds one limit of this “box” due to drift toward the stable node, a maneuver is normally performed to send it to the opposite limit of the “box”.

These east/west maneuvers are somewhat complicated by solar pressure on the large solar panels and RF antennae. This disturbance advances the perigee perpendicular to the sunline and thus rotates the e vector away from Aries. Standard east/west station-keeping builds in an e vector that lags the sunline to account for this disturbance. This “sun synchronous” station-keeping only requires a single maneuver to change the drift direction and rotate the e vector to account for the solar perturbation between maneuvers. An alternative but also will known method performs two maneuvers each cycle to reverse the drift rate and maintain the eccentricity near zero. East/west station-keeping typically requires ˜2 m/sec velocity increment per year that represents about 4% of the propellant required for geostationary station-keeping. This implies that spacecraft can operate in geosynchronous inclined orbits at very little propellant cost.

### North-South Motion, Perturbations

FIG. 2 illustrates that the latitude of a geostationary spacecraft varies sinusoidally at diurnal rate with a maximum defined by the residual inclination. The spacecraft is typically contained in a north/south latitude “box” of 0.1 deg. The inclination i of a geosynchronous/geostationary spacecraft is disturbed by “gravity gradient” torques due to the sun, moon and earth equatorial bulge. The equator is oriented ˜23 deg from the ecliptic plane, the path of the earth around the sun.

The differential pull of the sun over a year as the geostationary spacecraft orbits the earth in the equator increases the “I” vector magnitude by 0.27 deg along a direction 90 deg ahead of Aries; this differential pull over a year also regresses the i vector (rotates it clockwise with respect to Aries) 0.56 deg/yr. The moon is in an orbit the varies +−5 deg from the ecliptic over an 18.6 year period.

The differential pull of the moon over a year(smaller but closer) as the geostationary spacecraft orbits the earth in the equator increases the i vector magnitude by ˜0.6+−0.124 deg along a direction 90 deg ahead of Aries; this differential pull over a year also regresses the i vector 1.23+−0.13 deg/yr. The earth's equatorial bulge does not change inclination but rather regresses the i vector 4.93 deg/yr. The total results from all three perturbations are:

Delta i=0.87+−0.124 deg/yr along 90 deg ahead of Aries

Delta RAi=−6.72+−0.13 deg/yr

These perturbations result in an inclination change of ˜0.1 deg every six weeks. The north/south maneuvers performed on geostationary spacecraft compensates for the inclination increase by moving the i vector to ˜0.05 deg in a direction 90 deg behind Aries so that the north/south latitude “box” of +/−0.05 deg is maintained. The small nodal regression during the station keeping cycle is negated at negligible cost. North/south station-keeping typically requires ˜48 m/sec velocity increment per year and represents about 96% of propellant required for geostationary station-keeping.

### Satellite Radio Frequency

Modern telecommunications and earth observation satellites use radio frequency as a means of communications with the ground. The International Telecommunication Union (ITU), an agency of the United Nations, has set aside space in the super high frequency (SHF) bands located between 2.5 and 22 GHz for satellite transmissions. They are designated as: S band (2 to 3 GHz); C band (3 to 6 GHz); X band (7 to 9 GHz); Ku band (10 to 17 GHz); and Ka band (18 to 22 GHz). At these frequencies, the wave length of each cycle is so short that the signals are called microwaves. These microwaves have many characteristics of visible light: they travel directly along the line of sight from any satellite to its primary coverage area and are not impeded by the Earth's ionosphere.

The world's first commercial satellite systems used the C band frequency range of 3.7 to 4.2 GHz. By the late 1960s, many telephone companies around the world had numerous terrestrial microwave relay stations operating within the 3.7 to 4.2 GHz frequency range. The amount of power that any C-band satellite could transmit had to be limited to a level that would not cause interference to terrestrial microwave links.

The first commercial Ku band satellites made their appearance in the late 1970s and early 1980s. Relatively few terrestrial communications networks were assigned to use this frequency band; Ku-band satellites could therefore transmit higher-powered signals than their C-band counterparts without causing interference problems down on the ground.

Ku-band satellite antennas have a much narrower beam width, the corridor through which the dish looks up at the sky, than C-band parabolic antennas of a given diameter. There is a direct relationship between wavelength and antenna beam width: the shorter the wavelength, the narrower the beam width.

The International Telecommunication Union has assigned S-band frequency spectrum for direct-to-home (DTH) TV transmissions, and Indonesia is currently using this band for their DTH services. One limiting factor has been the bandwidth available: just 150 MHz of spectrum from 2.5 to 2.65 gigahertz.

### Fixed Satellite Services Business Overview

Operators for fixed services satellite (“FSS”), which is one of the most established in the satellite industry, provide satellite capacity for services between two fixed points (point-to-point services) and from one fixed point to multiple fixed points (point-to-multipoint services). Point-to-point applications include telephony, video contribution (also known as satellite news gathering) and data transmission (such as Internet backbone connectivity). Point-to-multipoint applications include broadcast applications such as video distribution and direct to home (DTH) services.

FSS satellites appear to remain at fixed locations in the sky and as a result, each FSS satellite provides communications coverage to a fixed geographic area. An earth station antenna on the ground can continuously communicate with a particular FSS satellite if it is pointed on a “line of sight” basis to the correct orbital location.

FSS satellites are typically evaluated on: The size and shape of their coverage area, or footprint, and its match with the desired contour of the customer, the frequency and strength of the signal transmitted to the coverage area and the availability of transponders for a given application. A key measurement of signal quality within a satellite's coverage area is the intensity of transmission power as measured by its effective isotropic radiated power (“EIRP”) at both beam center and edge of coverage. A higher EIRP, measured in decibel watts (“dBW”), enables the DTH service provider to use a smaller, lower-cost antenna on the ground. Customers will also evaluate a satellite's suitability by considering its remaining operational life and the number of available transponders capable of supporting the customer's unique applications. Customers also assess whether or not the satellite operator's fleet offers sufficient in-orbit backup and expansion capacity.

Today, FSS satellites typically operate in C-band and Ku-band. C-band frequencies (4 GHz to 8 GHz) have lower power and relatively longer wavelengths and as a result typically require larger antennas (3 meters to 12 meters). C-band frequencies are typically used for video distribution, telephony and certain other voice and data applications where small antenna size is not critical. Ku-band frequencies (12 GHz to 18 GHz) have higher power and relatively shorter wavelengths and can operate with smaller antennas (60 centimeters or less). Accordingly, Ku-band frequencies are well suited for consumer DTH satellite television, broadband Internet applications, very small aperture terminal (“VSAT”) networks and other applications where minimizing the size and cost of earth station terminals facilitates adoption. In the case of Indonesia, Southeast Asia and India, where rain attenuation can present a challenge, S-band (2 GHz to 4 GHz) can be used for consumer DTH satellite television applications because its lower frequency is well suited to local conditions.

### Ground Antenna in Geostationary Satellite Applications

### Antenna Types

### Parabolic Antennas

Most satellite ground antenna dishes incorporate a parabolic curve into the design of their bowl-shaped reflectors. The parabolic curve has the property of reflecting all incident rays arriving along the reflector's axis of symmetry to a common focus located to the front and center. The parabolic antenna's ability to amplify signals is primarily governed by the accuracy of this parabolic curve.

### Cassegrain Antennas

The cassegrain antenna is most often used for dishes that exceed five meters in diameter. Its use is primarily restricted to uplink earth stations and cable TV head ends. The cassegrain design incorporates a small sub reflector located at the front and center of the dish. The sub reflector deflects the microwaves back toward the center of the reflector, where the feedhorn is actually mounted. This type of antenna obtains higher efficiencies because the feedhorn looks up at the cold sky and the required illumination taper is reduced. This type of antenna are however expensive and complex and is not common for low cost application.

### Spherical Antennas

The spherical antenna design creates multiple focal points located to the front and center of the reflector, one for each available satellite. The curvature of the reflector is such that if extended it outward far enough along both axes it would become a sphere. Spherical antennas are primarily used for commercial television and cable installations where the customer wishes to simultaneously receive multiple satellites with a single dish. These satellites must be within +/−20 degrees of the reflector's axis of symmetry.

### Planar Arrays

Some digital DTH systems in Japan and elsewhere have elected to use an alternate antenna design called the planar array. These flat antennas do not rely on the reflective principles used by all parabolic dishes. Therefore no feedhorn is required. Instead a grid of tiny elements is embedded into the antenna's surface. These elements have a size and shape which causes them to resonate with the incoming microwave signals. One main disadvantage of the planar array is its limited frequency bandwidth which is about 500 MHz. Another disadvantage of the planar array is the high construction cost.

### Antenna Configurations

### Prime Focus Antennas

The basic design principle of the parabolic/spherical curve can be incorporated into antenna designs in a variety of ways. Dishes with a focal point directly at the front and center of the reflector are called prime focus antennas. Prime focus antennas are easy to construct and point toward the desired satellite. There are two main design disadvantages, however: the feedhorn and feed support structure block part of the reflector surface and the feedhorn must look back at the dish at such an angle that it can also intercept noise from the “hot” earth located directly behind the reflector.

### Offset-Fed Antennas

The dish design of choice for most digital DTH systems is called an offset-fed antenna. Here the manufacturer uses a smaller subsection of the same parabolic/spherical curve used to produce prime focus antennas, but with a major axis in the north/south direction, and a smaller minor axis in the east/west direction.

### Ground Receive Antenna Sensitivity

The ground receive antenna sensitivity is to first order dependent on the size of the antenna and the related wavelength of transmission. In general for a given size antenna, higher frequency has higher sensitivity. As the signal path moves off axis, the signal sensitivity drops off rapidly. Typical measure of sensitivity drop-off is the 3 db point. As an example, the following table illustrates the 3 db off axis signal drop-off of Ku, C and S bands.

TABLE
Antenna size vs. Look Angle Signal loss

| | Antenna | | | (−3 bd) angle from | | |
|---|---|---|---|---|---|---|
| | Gain (dbi) | | | look axis (deg) | | |
| Antenna Size | Ku | C | S | Ku | C | S |
| 30 cm | 30 | 20 | 16 | 3 | 9 | 13.7 |
| 60 cm | 36 | 26 | 22 | 1.4 | 4.5 | 6.8 |
| 1.2 m | 42 | 32 | 28 | 0.7 | 2.3 | 3.4 |
| 2.4 m | 48 | 38 | 34 | 0.4 | 1.1 | 1.7 |
| 3.6 m | 51 | 42 | 38 | 0.25 | 0.75 | 1.1 |
| 4.8 m | 54 | 44 | 40 | 0.19 | 0.56 | 0.9 |

As an example, for a Ku DTH antenna of 120 cm in size, when the satellite in inclined orbit has an inclination greater than 0.7 degrees, at the extreme of the inclination, the ground antenna will have a sensitivity reduction of at least 3 db. For an S band DTH antenna of 120 cm in size when the satellite in inclined orbit has an inclination greater than 3.4 degrees, at the extreme of the inclination angle, the ground antenna will have a sensitivity reduction of at least 3 db. Since S band is less sensitivity to rain and weather, S band can withstand higher inclination without losing signal for normal service.

Theoretically, at 0.87 degree increase in inclination per year without North-South station keeping, an S band satellite providing DTH services will continue to provide service for approximately three years after North South fuel is depleted. With the implementation of a three feed antenna, one point at 0 degree, one at +2 degree and one at −2 degree, with the correct switching algorithm employed with this invention, an additional three to four years of useful service life can be obtain for a satellite at the end of fuel life.

What is needed is an inexpensive simple system for maintaining communication with inclined orbit geostationary satellites.

### SUMMARY OF THE INVENTION

The present invention provides an inexpensive simple system for maintaining communication between fixed receivers on the earth surface having fixed antennas and inclined orbit geostationary satellites. For a ground antenna situated at the same longitude as the satellite the fixed antennas of each receiver are provided with more than one feed horn (such as three or more feed horns) each positioned to form a beam with its antenna in a slightly different direction from beams of the other feed horns in the north-south direction. An algorithm is developed based on the known daily swings of the inclined orbit geostationary satellite which determines which of the feed horns provides a beam providing the maximum signal from the satellite. Electronics are provided in the receiver to switch from feed horn to feed horn throughout each day to maintain adequate communication between the antenna and the satellite. In preferred embodiments the algorithm is utilized by a central station to periodically during each day determine which feed horn in each of many receivers are to be activated and a control signals are broadcast to the receivers which are programmed to switch to the designated feed horn based on the control signal. In other preferred embodiments receivers may be programmed individually based on the algorithm or a similar algorithm to switch feed horns to adequately maintain communication with the inclined orbit geostationary satellite. Additional detailed descriptions of various preferred embodiments are provided in the attached document which is a part of this provisional patent application. For a ground antenna situated at a different longitude and latitude from the satellite, the multiple feed horns will be situated at an angle to the north-south direction depending on the relative longitude and latitude.

### BRIEF DESCRIPTION OF THE DRAWINGS

FIG. 1 is a sketch showing spacecraft eccentricity.

FIG. 2 is a sketch showing an edge view of spacecraft orbit plane.

FIG. 3 is a sketch showing a ground antenna with multiple feed horns.

FIGS. 4, 5 and 6 are logic flow diagrams.

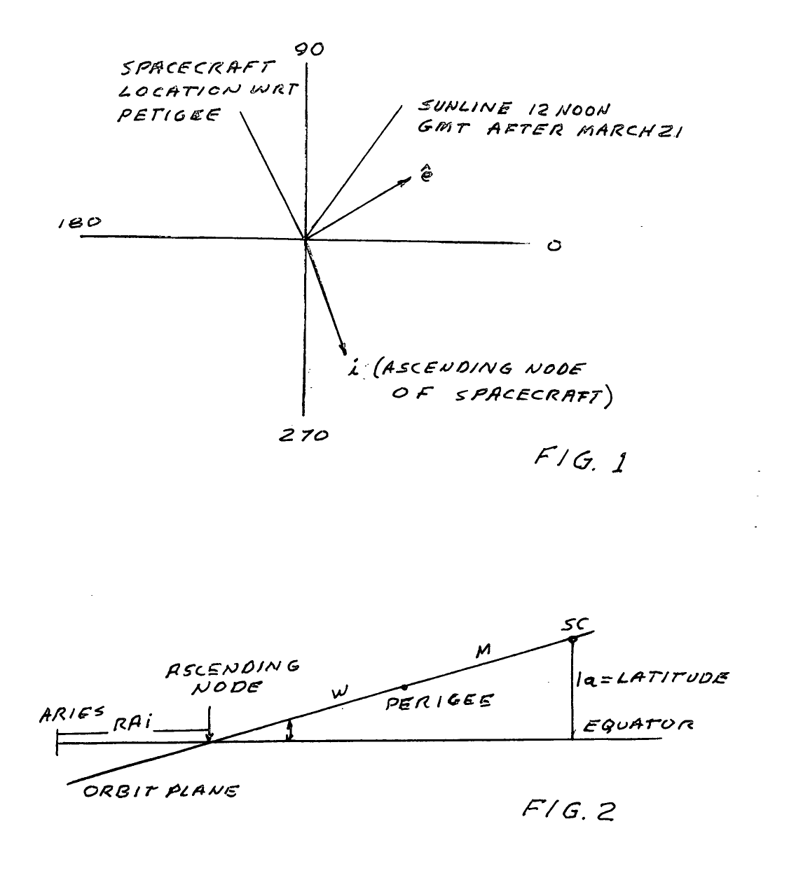

### DETAILED DESCRIPTION OF PREFERRED EMBODIMENTS

### Orbital Adjustment of a Geosynchronous Satellite with No North-South Station-Keeping

When north-south station-keeping is terminated, inclined orbit operations typically begin. The satellite is assumed to be at the edge of its north/south box with an inclination starting at ˜0.1 deg, an ascending node near 90 deg and longitude maintained at its nominal station. The inclination wants to grow at ˜0.87 deg/yr along 90 deg ahead of Aries. The node, however, wants to regress at ˜6.72 deg/yr. What is important to note is that nodal regression with time reduces the amount of inclination increase as the node moves away from the direction of increase and the regression rate is reduced because of the increase in inclination along the 90 deg direction. It can be shown that, approximately:

i=2(0.87)cos(RAi)/(6.72/57.3)deg/yr=14.84 cos(RAi)deg/yr

RAi=(90−(6.72/2)t)deg=(90−3.66t)deg where t is time from zero in years

Note that the regression rate is reduced by a factor of 2 due to the secular increase in i along the 90 deg axis. As RAi regresses from 90 to 0 deg during the first 24.6 yrs, the inclination increases from ˜0 to 14.84 deg. During the next 24.6 yrs, RAi regresses from 0 to ˜90 deg and the inclination decreases from 14.84 to 0 deg. The tip of the i vector traces out a circle centered ˜7.5 deg toward Aries. This cycle repeats ˜every 50 yrs and describes the inclination grave of all geostationary satellites.

Some satellites like weather and global coverage communication spacecraft fly in geosynchronous orbits from the start of operations when they first got into geosynchronous orbit. The technique they use to limit north/south motion is to establish an initial inclination with a node near −30 deg. Initial inclinations up to 6 deg will take 9 years before the inclination declines to 0 and gets on the graveyard circle described above. This technique is also been used for a satellite like Thuraya which limits the inclination to 6 deg over 15 yrs without north/south station-keeping.

A new and novel technique sets up an initial inclination condition before the satellite north-south station keeping propellant is exhausted so that the subsequent inclination can be minimized over several years. For example, if the final 14 months of north-south station keeping propellant (−1 deg inclination correction) is saved, the inclination after a year would increase to ˜0.87 deg. If instead, this saved propellant is used to increase inclination to 1 deg, with a node between 0 and −10 deg, the inclination over the next 5 yrs would be less than 1 deg. Effectively, 14 months of geostationary operations/1 yr of inclined orbit (<1 deg) operations are traded for 5 yrs of inclined orbit (<1 deg) operations. Satellites that can operate with this inclination with or without the help of the ground antenna described in this invention will have an inclination of no more than 1 degree for 5 years. This effectively extends useful service life by 3 years in many circumstances. Only east-west station keeping propellant is required to maintain longitude.

The invention does not limit the setting up of initial condition to the above mentioned condition, which is just one example of the result of the invention. The invention describes a technique that can vary the initial condition of i and RAi to arrive at any inclination condition. For some applications, it might be more advantageous to trade inclination angle and useful service life with a combination of this technique and the ground antenna described herein. In addition, a combination of starting operations, at the beginning of life, with an initial inclination of any number of degrees i and any RAi to fit any operations scenarios, coupled with the ending inclination described above is also part of this invention. The regression of the ascending node due to the sun, moon, and the earth bulge at the equator results in an earlier time of the ascending node arrival of 3.66 deg/yr, 0.23 hr/yr, 0.035 min/day.

### Combination of Orbit Adjustment and Antenna Implementation with Multiple Feed Horns

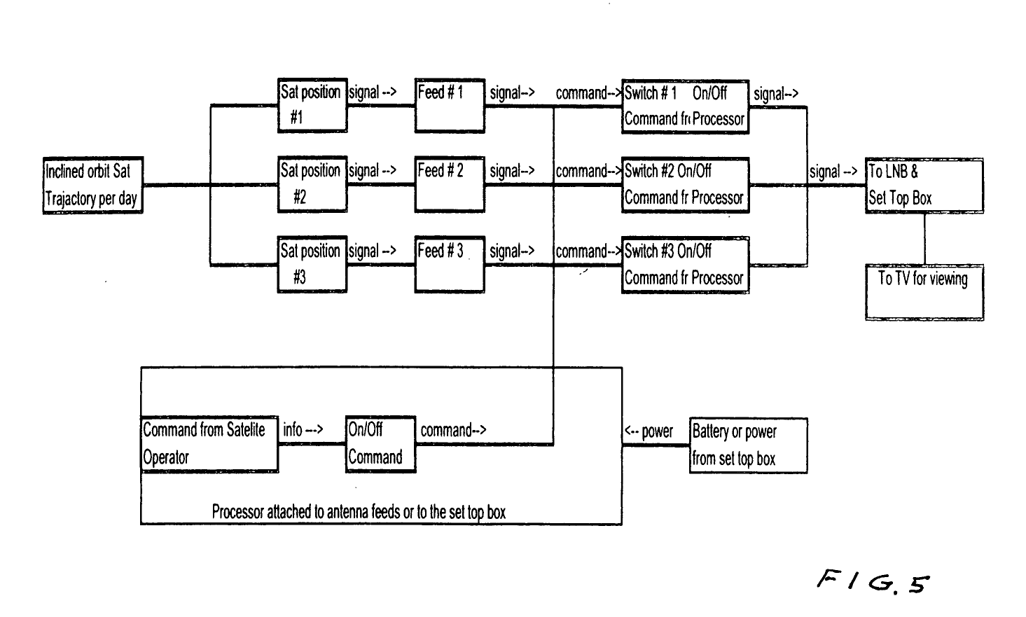

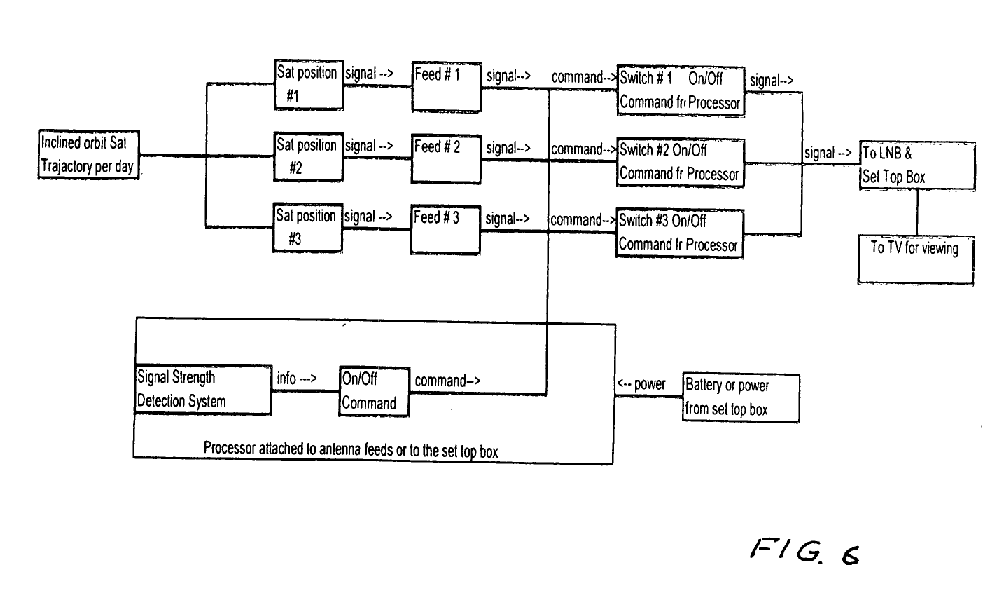

This perturbation can be handled on a monthly correction of 1.1 minutes in the algorithm. As the inclined orbit satellite traces out a North-South FIG. 8 trajectory in the sky once a day, its primary signal axis will be closest to one of the feeds, that particular feed will be turned on or off based on a set of computation that is either stored on board the antenna (or set top box) in a simple processor. The processor will also send a command to the switch that switch on the signal path of that particular antenna feed. FIGS. 4 and 5 are block diagrams representation of the implementation scheme using an open loop system relying on a processor that compute the location of the satellite in a north-south trajectory and command a switch to switch on the feed that corresponds to the closest axis of the line of sight of the satellite and receives the strongest signal from the satellite. Other implementations using a closed loop system by relying on a discriminator provided by the ground operator, or an automatic signal detection system, can also be implemented. FIG. 6 illustrates such a system.

In addition, the fixed ground antenna need not have multiple feeds. Sometimes, one might want to use a set of ground antenna pointing at different location covers by the trajectory of the inclined orbit satellite. In other implementation, the fixed multiple feed antenna can also be replaced by a phase array antenna, or a multiple element digital beam forming antenna, or an electrically steerable feed horn that depending on the biasing of a dual dipole antenna.

As mentioned prior, without North-South station keeping, due to gravitational influence of the sun and the moon, the satellite will slowly change its inclination over time and the incline plane will oscillate north and south every day. The inclination grows at about 0.87 degree per year so that after three years, the inclination will increase to ˜2.6 degrees and oscillates once per day within that inclination. An S band satellite providing DTH services using a fixed ground antenna of approximately 1.2 meter will continue to provide service for approximately two to three years after North South fuel is depleted, without losing significant satellite signal. Beyond that, it becomes impractical to continue service.

With the implementation of a fixed antenna of the same 1.2 meter size but with three feeds, one point at 0 degree, one at +2.5 degree and one at −2.5 degree, with the correct switching algorithm employed with this invention, an additional three to four years of useful service life can be obtain for a satellite at the end of fuel life. This will provide significant economic benefits to the satellite operator and DTH service provider as they will not have to replace the satellite as often.

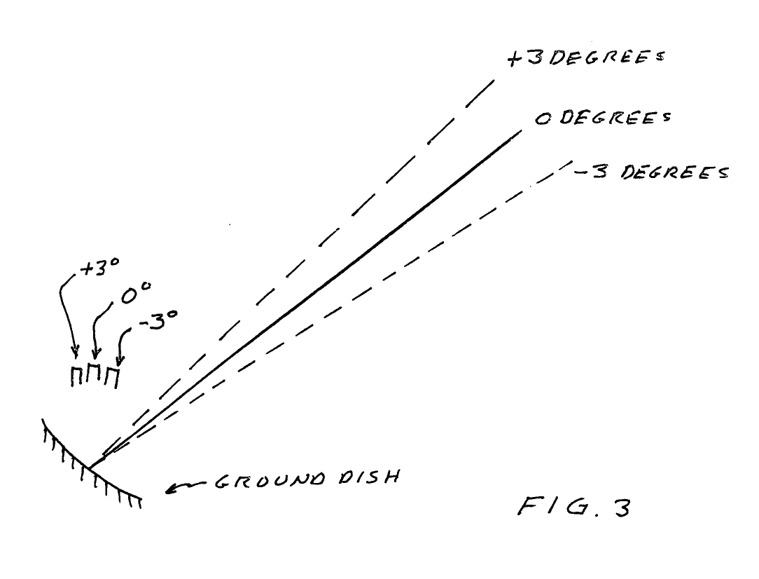

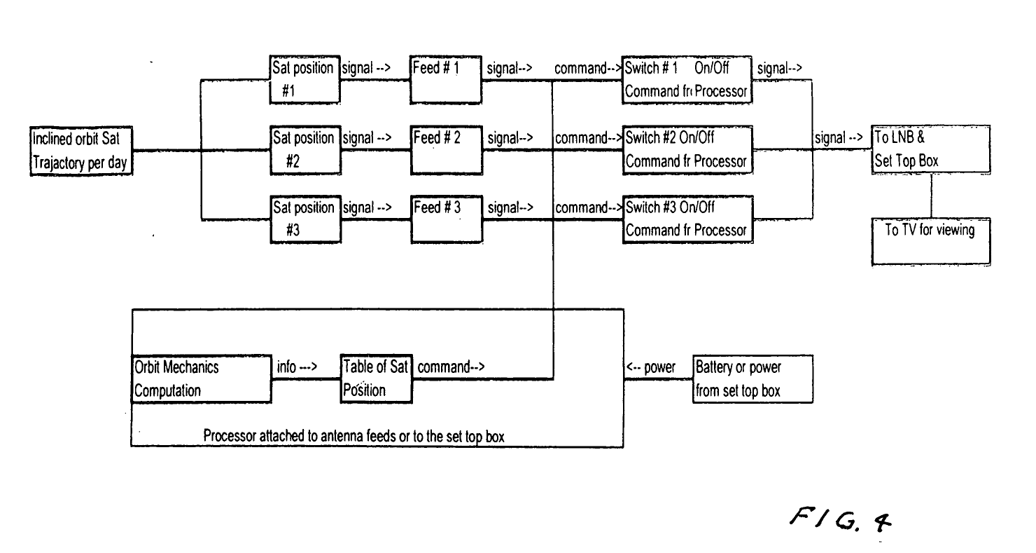

FIG. 3 shows an offset ground dish antenna situated at the same longitude as the satellite with three feeds, each looks directly at a position in space corresponding to the satellite at inclination angles of +2, 0 and −2 degrees. Feed #1 looks at +2 degree, so it will detect maximum signal when the satellite is located at +2 degree inclination, and so on. In principle, the number of feed horns is not limited to 3 and can be as many as practical.

FIG. 3 also represents a single feed horn controlled by a stepper motor with a three position steps. The stepper motor is commanded by information provided to it so it can be switched to occupy a pointing position that is closest to the location of the inclined orbit satellite position. In general, the stepper motor is not limited to three positions but can have multiple positions corresponding to the inclined orbit satellite's position in the sky, up to + or −7.3 degree inclination.

There are other methods that can be implemented to take advantage of this invention concept. Instead of multiple-feeds single antenna or a single feed with a stepper motor, one can deploy a number of independent antenna elements, each looks at a position in space corresponding to the particular inclination angle, the antennas can be tied together similar to methodology depicted in FIG. 8 or an antenna feed that can be steered electronically. In addition, a phase array antenna, or a digital beam forming antenna element can also be used. Therefore, the invention and concept is independent of how it is implemented. Here, we simply mentioned several practical method of deployment as examples.

### Antenna Reflector Configuration

A ground reflector that can accommodate a multiple feed horns arranged in a north-south direction, or a feed horn that can be moved in a north-south direction to intercept the satellite signal for a satellite in a north-south inclined orbit can be designed using the techniques described above. One obvious implementation is to use a spherical reflector. Another implementation is to use a hybrid shaped reflector that is cylindrical in a north-south direction but parabolic in a east-west direction. Again, these are mentioned for illustration purpose and the invention does not limit reflector design to the two mentioned above.

### Special Techniques

With the present invention many potential techniques are available to extend the useful life of communications. Some of these techniques are summarized below;

The initial condition of inclination i of a satellite and ascending angle RAi can be adjusted so that the inclination of the satellite after north-south station keeping is stopped can be set to fit the operations scenarios of fixed satellite services. For example when the satellites initiate inclined orbit operations when the final 14 months of north-south station keeping propellant (˜1 deg inclination correction) is not used for inclination control, the inclination i after a year would increase to ˜0.87 deg. At this time then, the remaining propellant is used, to increase inclination to 1 deg, with a node, RAi, between 0 and −10 deg, the inclination over the next 5 yrs would be limited to less than 1 deg. Effectively, 14 months of geostationary operations/1 yr of inclined orbit (<1 deg) operations are traded for 5 yrs of inclined orbit (<1 deg) operations. Satellites that can operate with this inclination with or without the help of the ground antenna described in claim 1 will have an inclination of no more than 1 degree for 5 years. This effectively extends useful service life by 3 years in many circumstances. Only east-west station keeping propellant is required to maintain longitude.

Satellites can be set to any initial inclination of i degrees, and any ascending node of RAi degrees, to obtain any inclined operations that is suitable for any geosynchronous satellite services. Moreover, this technique can also be repeated many times in combination over time, if desired.

The basic plan is that as the satellite travels to the location closest to each one of the feed horn's pointing position, that particular feed horn is activated and receives signal from the inclined orbit satellite. As the satellite travels out of the location of that particular feed horn, another one closest to the satellite location is switched on, and this particular one is then switched off. There will always be one feed horn that is on at all time. In addition, the feed horn that is on at the time will be the feed horn that receives the strongest signal from the satellite. The feed horn to switch on is provided and determined by a precise computation of the location of the inclined orbit satellite using orbit mechanics calculation and information from satellite operations.

The computation using orbit mechanics to determine the location of the inclined orbit satellite over time can be performed prior to installation of the antenna, and the information, calculation and switch command can be performed and stored in a processor. Such processor can then be installed either at the base of the antenna and feed horn or at the set top box equipment location. The processor can be powered by a battery or by electrical power supplied by power from the set top box.

The computation using orbit mechanics to determine the location of the inclined orbit satellite over time can also be down loaded from the satellite, or from remote locations to the antenna and processor and the switching decision performed based on the information. In addition, updates and corrections of the information can be down loaded from the satellite, or from remote locations to the antenna and processor and the switching decision performed based on the information.

The feed horn to be switched, can be provided and determined by the information pointing the uplink tracking antenna use by the satellite operator to uplink signals to be transmitted to the end user ground antennas, or real time measurement provided by the satellite location, or by the satellite operators, or by other means. Which feed horn to switch can also be cued by using a closed loop system using the information of the location of the inclined orbit satellite, supplied by a discriminator which is provided by measuring real time intensity of the satellite signal.

In a variation of the above examples a single feed horn can connected to a stepper motor, which will position the feed horn on command to a position in the sky corresponding to the closest location of the inclined orbit satellite; by using a multiple set of ground antennas; by using a phase array antenna; or by a set of digital beam forming antennas to receive optimum signals from a geostationary satellite in inclined orbit. The claims include the methods of operations using the above mentioned antennas, coupled with a system using the precise calculation of orbit mechanics to predict the orbit location of the inclined orbit satellite over time.

While the above description contains many specifications, the reader should not construe these as a limitation on the scope of the invention, but merely as exemplifications of preferred embodiments thereof. For example, the number of feed horns could more or less than three in the ground based antennas. As indicated many antenna designs can be adapted for use with the present invention. A variety of techniques can be utilized to control the ground base antenna to keep them in touch with the satellite. Accordingly the reader is requested to determine the scope of the invention by the appended claims and their legal equivalents, and not by the examples given above.

1. A method of providing satellite services for ground customers by a fixed service satellite business with a geosynchronous communication satellite without north-south control comprising the steps of:
A) the fixed service satellite business providing ground customers with ground receive antennas directed toward the communication satellite, each antenna having a reflector and a plurality of feed horn positions, each feed horn position defining with respect to the reflector a feed horn position to receive satellite signals from a different north-south position near the geosynchronous orbit position above the earth's equator,
B) the fixed service satellite business calculating positions of the satellite as a function of time,
C) the fixed service satellite business determining the best feed horn in each of a plurality of ground receive antennas which is best located to receive the best signal from the satellite, and
D) the fixed service satellite business providing a control signal to the ground receive antennas to cause the best feed to receive the signal from the satellite.

2. The method as in claim 1 wherein a feed horn is position at each of the plurality of feed horn positions.

3. The method as in claim 2 wherein said control signal is provided to the ground customers and the ground customers provide the control to the receive antenna.

4. The method as in claim 2 wherein the control signal is provided from a central location directly to the receive antennas.

5. The method of claim 2 wherein the initial condition of inclination i and ascending angle RAi can be adjusted so that the inclination of the satellite after north-south station keeping is stopped can be set to fit the operations scenarios of fixed satellite services.

6. The method of claim 5 wherein the satellites that were expected to initiate inclined orbit operations when the final 14 months of north-south using station keeping propellant, instead this saved propellant is used to increase inclination to 1 deg, with a node, RAi, between 0 and −10 deg, in which case the inclination over the next 5 years will be limited to less than 1 deg; wherein 14 months of geostationary operations is traded for 5 yrs of inclined orbit operations, thereby extending useful service life of the satellite by about 3 years.

7. The method of claim 2 wherein one feed horn that is on at all time and the feed horn that is on at the time will be the feed horn that receives the strongest signal from the satellite.

8. The method of claim 2 wherein the computation using orbit mechanics to determine the location of the inclined orbit satellite over time can be performed prior to installation of the antenna, and the information, calculation and switch commands are stored in a processor in electronic communication with feed horns of each of a plurality of receive antennas.

9. The method of claim 8 wherein the processor can be powered by a battery or by electrical power supplied by power from a set top box.

10. The method of claim 2 wherein computations using orbit mechanics to determine the location of the inclined orbit satellite over time are down loaded from the satellite, or other remote location to the antenna and processor and the switching decision performed based on the information.

11. The method of claim 1 wherein the feed horn to be switched is determined by the information pointing the uplink tracking antenna use by a satellite operator to uplink signals to be transmitted to the end user ground antennas.

12. The method of claim 1 wherein a feed horn connected to a stepper motor, which is adapted to position the feed horn on command to a position in the sky corresponding to the location of the inclined orbit satellite.
